(19) United States
(12) Patent Application Publication
(10) Pub. No.: US 2013/0041734 A1
(43) Pub. Date: Feb. 14, 2013

(54) Method of Passing and Redeeming Coupons Via Webpage Accessed from Mobile Phone

(71) Applicants: Gregory S. Dean, San Francisco, CA (US); F. Rene Van de Carr, La Quinta, CA (US); Kedric Van de Carr, San Francisco, CA (US)

(72) Inventors: Gregory S. Dean, San Francisco, CA (US); F. Rene Van de Carr, La Quinta, CA (US); Kedric Van de Carr, San Francisco, CA (US)

(21) Appl. No.: 13/441,351

(22) Filed: Apr. 6, 2012

Related U.S. Application Data
(60) Provisional application No. 61/472,478, filed on Apr. 6, 2011.

(51) Int. Cl. G06Q 30/02

(52) U.S. Cl. 705/14.23

(57) ABSTRACT

A method of passing and redeeming coupons via webpage accessed from mobile phone for facilitating the process of passing and redeeming coupons via a web page accessed from a mobile device. The method of passing and redeeming coupons via webpage acessed from mobile phone generally includes a method by which a Uniform Recourse Locator (URL) is electronically transferred to a mobile phone device for the purpose of allowing conditional access to coupons, premiums or discount offers.

### CROSS REFERENCE TO RELATED APPLICATION

This application claims priority to U.S. provisional patent application, Ser. No. 61/472,478, filed Apr. 6, 2011. Priority to the provisional patent application is expressly claimed, and the disclosure of the provisional application is hereby incorporated herein by reference in its entirety and for all purposes.

### FIELD

The present disclosure relates generally to methods and systems for passing and redeeming coupons via webpages accessed from mobile phones.

### BACKGROUND

A majority of the revenue generated by brick and mortar retailers and consumer products goods (CPGs) companies is generated within an actual physical store. Retailers and (CPGs) do not have any method for tracking the in store impact or in store Return On Investment (ROI) of any specific media spend they make. In addition to this, retailers are often interested in providing a coupon, discount or other form of monetary value or benefit to potential customers to incentivize them to enter a store to purchase their goods. In addition, retailers need a coupon distribution and redemption method which offers scalability to a majority of the cell phones in the market they are displaying media within. Retailers and CPG companies need a scalable method to track in store impact of each ad spend which they make.

### SUMMARY

The invention generally relates to a business method with computer software which includes a method by which a Uniform Recourse Locator (URL) is electronically transferred to a mobile phone device for the purpose of allowing conditional access to coupons, premiums, vouchers, giftcards, or discount offers. It is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

One aspect of the present disclosure is to provide a method of passing and redeeming coupons via a webpage accessed from a mobile phone. Another aspect of the present disclosure is to provide a method by which customers will receive a URL to their mobile device originating from a text message, QR Code, near field communication enabled into some form of media, URLs, Bluetooth, email, or the like, on their mobile phone device.

Another aspect of the present disclosure is to provide a method by which a customer will click a URL and be taken to a page where he or she is instructed to enter or provide in some way a unique piece of information to indicate that the customer is in a store and or that the customer is making a purchase in a store (either physical or electronic).

Other aspects and advantages of the present disclosure will become obvious to the reader and it is intended that these aspects and advantages are within the scope of the present disclosure. To the accomplishment of the above and related aspects, this disclosure may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other aspects, features and attendant advantages of the present disclosure will become fully appreciated as the same becomes better understood when considered in conjunction with the accompanying drawings, in which like reference characters designate the same or similar parts throughout the several views, and wherein:

FIG. 1 is a flowchart illustrating a sub-operation of the present disclosure.

FIG. 2 is a flowchart illustrating a sub-operation of the present disclosure.

FIG. 3 is a flowchart illustrating a sub-operation of the present disclosure.

FIG. 4 is a flowchart illustrating a sub-operation of the present disclosure.

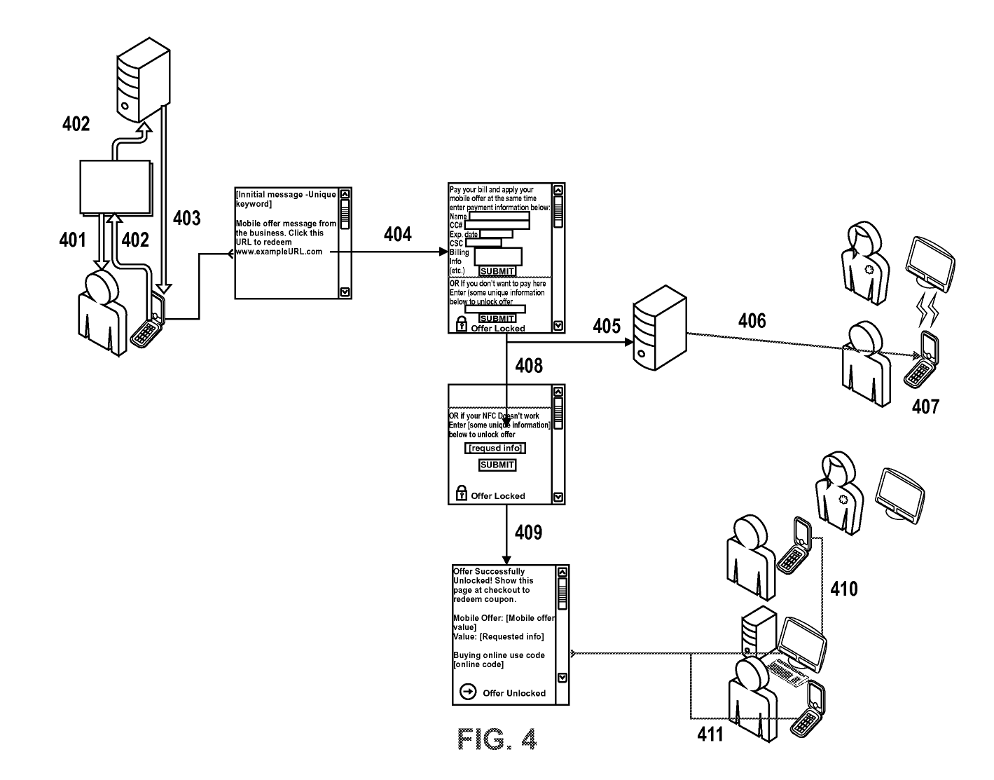

FIG. 5 is a flowchart illustrating a sub-operation of the present disclosure.

FIG. 6 is a flowchart illustrating a sub-operation of the present disclosure.

### DETAILED DESCRIPTION

The figures illustrate methods by which, for example, a Uniform Recourse Locator (URL) is electronically transferred to a mobile phone device for the purpose of allowing conditional access to coupons, premiums or discount offers.

The methods of the present disclosure include a mobile offer transfer element. The mobile offer transfer element will include software needed to select target mobile devices using appropriate offer specific preset discrimination filters to allow the least expensive and most effective use of facilities. The mobile device may include a PDA, mobile/cellular phone, smartphone, tablet, or the like. The software will utilize text messages, QR code, near field communication, Bluetooth, email or the like to facilitate the transmission of the universal resource locator (URL) to the mobile device of the consumer. The offer software is modified to maximize effectiveness and minimize expense of the method by utilizing factors such as zip codes, business proximity, time of day, and other relevant factors in selecting targeted mobile phone units.

The method further includes webpages or other page response elements that are transmitted by the mobile offer transfer element to a customer. Web pages may be offer specific, time limited, illustrated or non-illustrated but allow for consumer input for the purpose of validation. When the customer is in the store (either physical location or web store) she will click the universal resource locator (link) and be taken to the web page or pages where she will be instructed to enter information such as bill total, or basket total, products purchased, and/or service purchased. The customer may also be required to enter or share a unique store code, store address, GPS location, cell tower triangulation, wifi location, and or sales classification. In a separate embodiment the user's action of simply clicking the URL while in the store will allow for the verification she is in the store. Such a code will indicate that the customer was in a store and/or that they made a purchase in a store (either physical or electronic).

In an alternative embodiment, the customer or user clicks the universal resource locator which does not result in a web page but instead activates the NFC Reader (near field communication) chip in their mobile device. The user then holds the device near the NFC (near field communications) reader, then at the retail store and the discount or offer or value is automatically applied to their transaction or engagement or value is given to the user in some way. The second option is enter or share the information being requested then click, for example, “submit” to unlock the offer which the user will show to the retailer, and the retailer will then apply to the bill total or transaction, same as the scenario described above.

The methods of the present disclosure may further include validation and/or sales tracking steps. The validation requires input of sales information including items, purchase price, location, date of purchase, and/or other desirable sales information which are itemized, summarized and trends or tendencies may be analyzed and submitted to advertisement initiators. In an exemplary embodiment, the validating step may unlock a coupon or benefit when sales information is inputted or shared that matches the unique validation code. The code may be generated by near frequency communicator, provided to customer by on site sales personnel, or the like.

In a further embodiment, when the user clicks the universal resource locator link, the software pushes a mobile value into the person's (mobile wallet) through the system of a third party mobile wallet provider or the system vendor of a third party mobile wallet provider. The user then accesses the mobile offer through the user's mobile wallet software on the user's mobile device to redeem at a store. The second option is enter the information being requested then click “submit” to unlock the offer which the user will show to the retailer, and the retailer will then apply to the bill total or transaction, same as scenario 1. In a preferred embodiment, the mobile numbers called, number of responses, amount of sales, time and location of sales, and other relevant information is transferred to advertising customers and or third party “Mobile Wallet Suppliers.”

In one variation the transaction is processed and the successful payment message is sent to the point of sale system to verify for the retailer or customer service representative that the payment has been successfully received. The second option is enter the information being requested then click submit to unlock the offer which the user will show to the retailer, and the retailer will then apply to the bill total or transaction.

The main elements and their sub-elements parts are a continuous method of passing, redeeming and monitoring coupons, offers, two for one offers, gift cards, store credit or some other item of value best visualized as a continual flow pattern as demonstrated in the figures. Exemplary flow patterns of embodiments or sub-routines of the present disclosure will now be explained in conjunction with the figures.

### Scenario 1

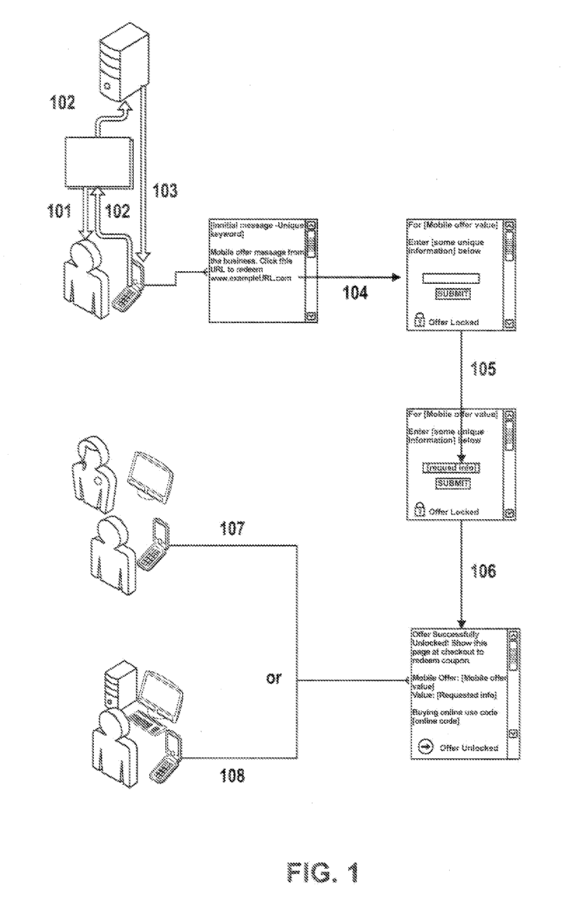

In a first exemplary embodiment of the methods of the present disclosure as shown in FIG. 1, the user or customer sees some form of media with a mobile call to action for some offer to be delivered to their mobile device (step 101). The message may be received via a text message, QR Code, tweet, social networking message, social media form of communication, near field communication enabled into some form of media, URL's, Bluetooth, email, or the like. When the customer is in the store (either in the physical location or on a web store), the customer responds back to the media call to action through their mobile device, by, for example, clicking on a provided URL (step 102). At step 103, the back end system sends a response to the customer's mobile device and the message is received on customer's mobile device. The customer then clicks on the provided URL and is taken to a new page (step 104). On this page, the customer is instructed to share her location via GPS, wifi, cell tower triangulation or some other means, enter her bill total or basket total, products purchased, service purchased, unique store code, a unique code, store address, or some other unique piece of information to indicate that the customer was in a store and or that they made a purchase in a store (either physical or electronic). The customer then submits this information (step 105). Once entered, this information will unlock a coupon, offer, 2 for 1 offer, gift-card, store credit, or some other item of value. The offer will be displayed as a new page, or it will dynamically change in some way to reveal or show that the offer is now unlocked or available for use (step 106). The customer then shows this success screen to the retailer when they are in store to redeem (step 107), or there will be a unique code on the page which allows the customer to then enter that code into an online store to redeem (step 108).

### Scenario 2

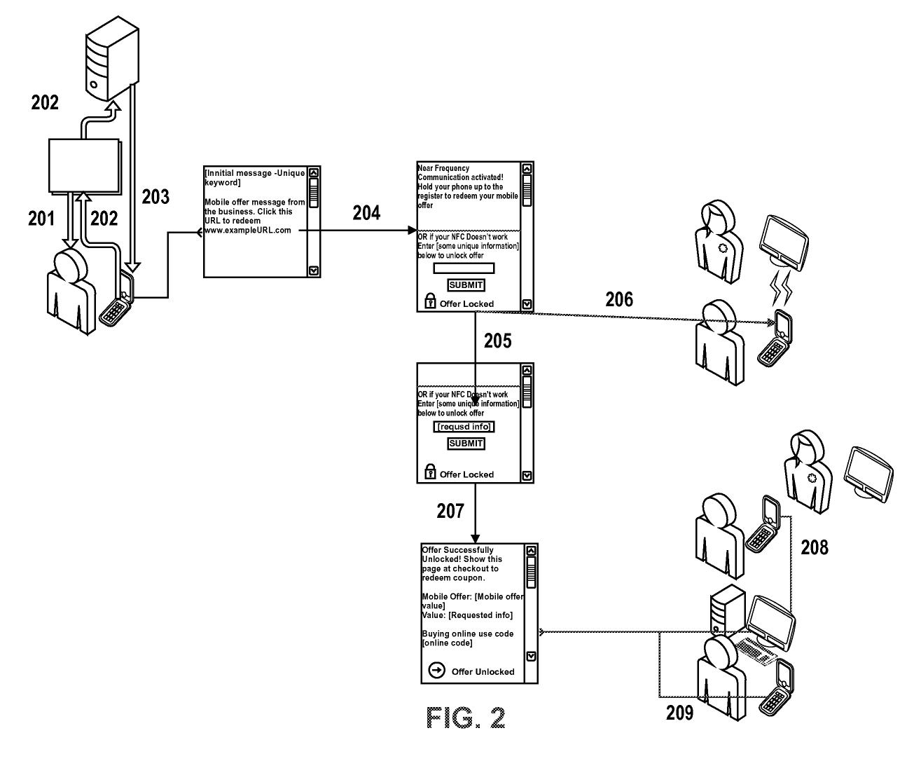

In a separate scenario depicted in FIG. 2, the process again begins with a customer or user viewing some form of media with a mobile call to action for some offer to be delivered to their mobile device (step 201). For example, a customer receives a URL to their mobile device. The customer then responds back to the media call to action using the customer's mobile device (step 202). The back end system then generates a response back to the customer's mobile device and the message is received on the customer's mobile device (step 203). Sometime after the customer clicks the URL (step 204), the NFC (near field communications) chip in the mobile device is activated. The user then holds the device near the NFC reader at the retail store and the discount or offer or value is automatically applied to their transaction or engagement, or value is given to the user in some way (step 206). Alternatively, if the customer's mobile device does not have a NFC chip or the chip is not presently working, the customer can enter information in response to a question presented to the customer on the mobile device (step 205). In this alternative, once information is entered and the submit button is clicked, the page becomes unlocked (step 207) and is ready to be redeemed. The redemption could take place at the point of sale by showing the success page to the cashier or at the point of sale to another representative who verifies the coupon information is correct and applies the mobile offer value to the basket or transaction (step 208) or the customer could enter a code supplied on the success page to make the purchase online (step 209).

### Scenario 3

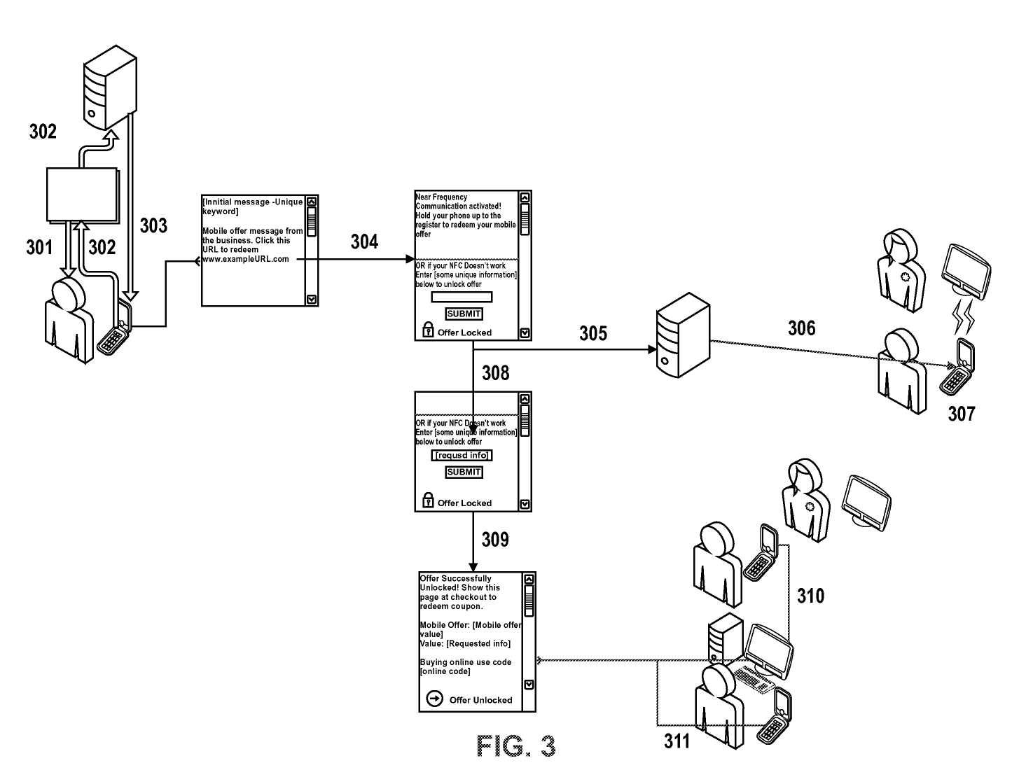

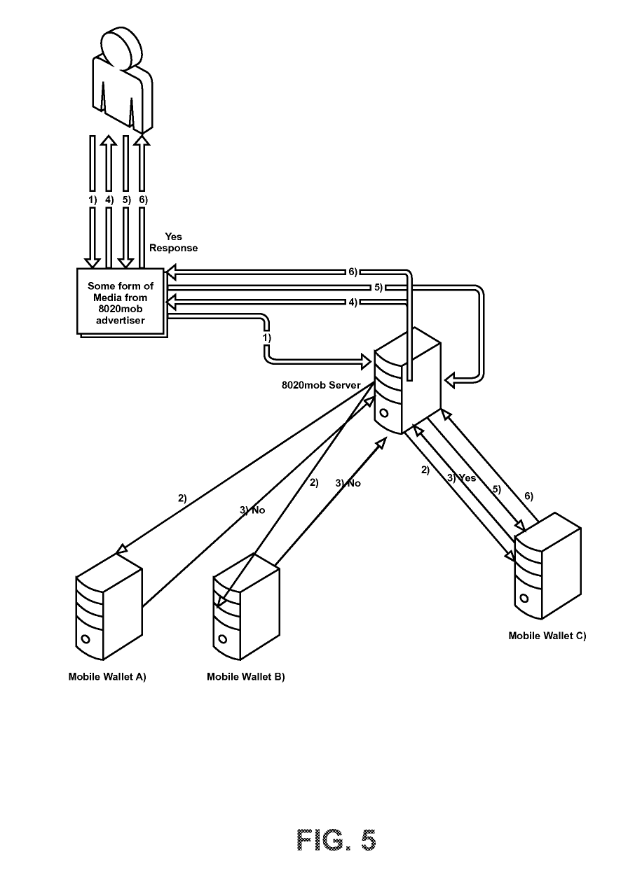

In a further alternative embodiment, as shown in FIG. 3, the process begins, as it in the first two scenarios, with a customer or user viewing some form of media with a mobile call to action for some offer to be delivered to their mobile device (step 301). The customer then responds back to the media call to action via the customer's mobile device (step 302). The back end system then generates a response back to the customer's mobile device and the message is received on the customer's mobile device (step 303). For example, the response may include a link. When the user clicks on the link (step 304), the system pushes a mobile value into the customer's “Mobile Wallet” through the system of a third party mobile wallet provider (steps 305 and 306), or the system vendor of a third party mobile wallet provider. The generation of a mobile wallet offer is discussed in further detail below in relation to FIG. 5. In the context of the present disclosure, a mobile wallet comprises software which is digitally stored on a mobile device that contains a method of payment through, for example, linking to some form of financial institution. The mobile wallet contains credits of value in the form of loyalty cards, loyalty programs, mobile coupons, gift cards, store credit, or the like. The credits are stored in electronic form on the device or in the cloud but can be redeemed on the mobile device through a customer's use of a mobile device to pay for goods or services. The mobile wallet is a third party digital platform which allows for electronic storage and redemption of digital offers and payment for goods via NFC, manual input or some other form of redemption.

Alternatively, if the customer's mobile device does not have mobile wallet software or the customer does not have access to a mobile wallet provider, the customer can enter information in response to a question presented to the customer on the mobile device (step 308). In this alternative, once information is entered and the submit button is clicked, the page becomes unlocked (step 309) and is ready to be redeemed. The redemption could take place at the point of sale by showing the success page to the cashier or at the point of sale to another representative who verifies the coupon information is correct and applies the mobile offer value to the basket or transaction (step 310) or the customer could enter a code supplied on the success page to make the purchase online (step 311).

### Scenario 4

In a fourth exemplary scenario or embodiment of the method of the present disclosure, the initial steps 401, 402, and 403 are the same as those described in reference to the first scenario (steps 101, 102, and 103). When the customer clicks on the link provided, a new page is provided wherein the customer is presented with two options for redeeming the mobile offer (step 404). The first option on the page is to pay the bill through the web page by entering payment information e.g. credit card info, Pay pal info, or the like (step 405). Once the payment information is submitted, it is sent to the system of a third party mobile payment provider, or the retailer's own mobile payment solution (step 406). The transaction is then processed and the successful payment message is sent to the point of sale system to verify for the retailer or customer service representative that the payment has been successfully received (step 407). Alternatively, the pathway can proceed with the customer entering requested information (step 408) to activate or unlock an offer (step 409). The customer can then complete the purchase at a point of sale (step 410) or online (step 411).

In a separate embodiment the user while in the store will click the URL and by doing so automatically begins to share her location (either actively or passively) via GPS, wifi, cell tower triangulation, or via a signal being emitted from within the store or in some other way the mobile device will recognize her being in the store. Once the mobile device recognizes that the user is within the store the success page is automatically loaded or displayed enabling the user to show the success screen and redeem her coupon, offer or other value.

In a separate embodiment the user while in the store will click the URL and be taken to a page where she will share her location (either actively or passively) via GPS, wifi, cell tower triangulation, or via a signal being emitted from within the store or in some other way the mobile device will recognize her being in the store. Once the mobile device recognizes that the user is within the store the success page is automatically loaded or displayed enabling the user to show the success screen and redeem her coupon, offer or other value.

In a separate embodiment, the user while NOT in the store, will click the URL and be taken to a page where she will share her location (either actively or passively) via GPS, wifi, cell tower triangulation or in some other way the mobile device will recognize her NOT being in the store. Once the mobile device recognizes that the user is NOT within the store a warning/block page is automatically loaded or displayed explaining to the user that they must be in the store to successfully redeem the coupon or offer. There may or may not be functionality allowing for the user chose to override the warning page and redeem the offer in-spite of not being within a store. This embodiment also applys to users who have mobile devices which do not support GPS, the GPS is not turned on or broken.

In a separate embodiment the user clicks the URL and by doing so automatically the server begins to detect if location services are supported by the device, if those location services are functioning and operational and the user declines or refuses or for any reason does not share her location when it would be possible to do so, then they system does not allow the user to proceed in the redemption process. The user will be re-prompted to share or provide location or some other method to verify that they are in the store until location or other information is secured from the user.

The creation of a mobile wallet offer is depicted in FIG. 5. An advertiser or other entity utilizing the platform of the present disclosure will create an advertisement or other form of media with a call to action within the creative of the advertisement or media itself The customer can respond to the call to action by (1) entering text into a short code contained within the advertisement or media; (2) clicking the advertisement which results in the customer being taken to a landing page where the customer they can enter her mobile phone number, email address, social networking credentials or all or any combination to receive the offer; or (3) engaging with some other form of media and in that process providing her mobile phone number, email address, social networking credentials or all or any combination (step 1).

The mobile phone number or email address of the device is received by the servers. An API request with the mobile phone number or email is then sent simultaneously to mobile wallet providers associated with the system of the present disclosure (step 2). The mobile wallet providers are queried to identify if the phone number or email address requesting an offer is a mobile phone which is enabled with or has the possibility to be enabled with the mobile wallet provider's software (step 3). If “no,” then a negative response is sent back to the server. If “yes,” then a positive response is sent back to the server.

The server then receives the responses from the mobile wallet providers. If there is one YES/positive/affirmative response that a mobile wallet is supported by the user's mobile device, the user is provided an option to load the offer to their mobile wallet, download the software for the mobile wallet with the offer already loaded into said software, or receive the offer via SMS (SMS redemption flow process continues in FIG. 1) (step 4). If the user chooses NO or the SMS option, then an SMS is delivered to their phone that they can redeem in store (SMS redemption flow process continues in FIG. 1, 2, 3, 4 or any embodiment or combination outlined in this document).

If they choose yes, then a “create an offer” request is sent to the mobile wallet provider or providers who provided an affirmative/yes response (step 5). The “create an offer” request contains the offer value, expiration, restrictions and other relevant information necessary for the offer to be useful. If the user decides to “download the mobile wallet software” to their phone (described in the previous step) then the user will simultaneously be sent an ability to download this software to their phone. When the mobile wallet provider successfully creates the offer, a success response is sent back to server via the API connection and the server then notifies the customer of the successful creation of the offer in their mobile wallet (step 6).

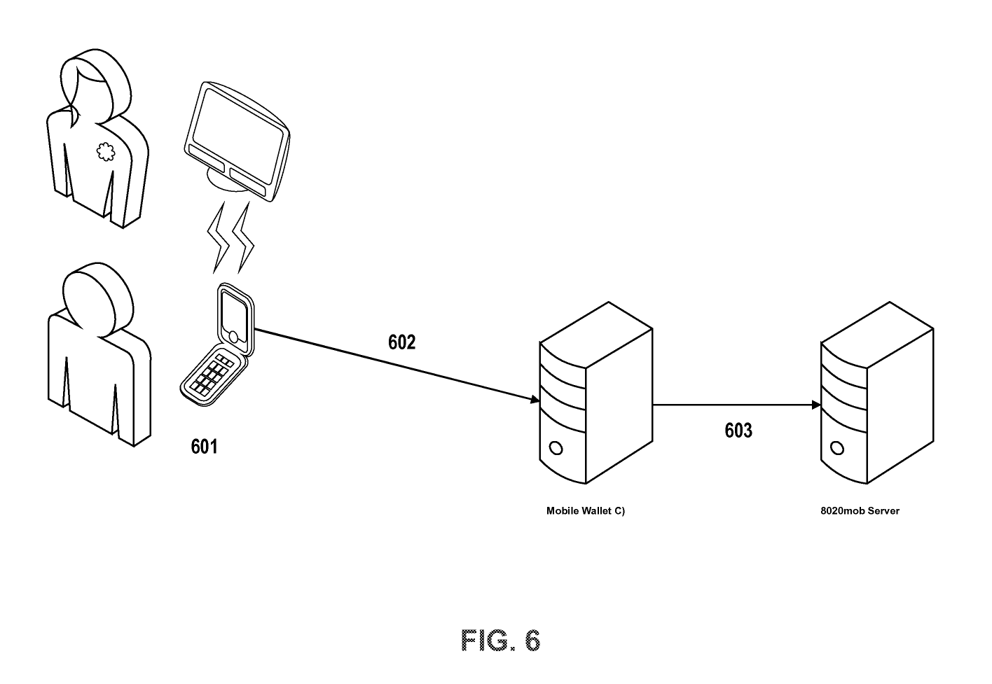

FIG. 6 illustrates an exemplary sub-routine of the present disclosure for redemption of a mobile offer for a customer using a mobile device. Following delivery of the offer to customer into the customer's mobile wallet, the customer accesses a retail store. The customer who has been delivered an offer into their mobile wallet then walks into a brick and mortar retail store to redeem the offer. The customer redeems the offer at a point of sale system utilizing NFC or some other redemption process offered by the mobile wallet provider (step 601). The mobile wallet provider's server is notified by either the device or the point of sale system that the offer has been redeemed and the mobile wallet provider captures the information about the transaction (step 602). The mobile wallet provider then passes information on the transaction such as offer number or identifier, bill total amount, unique offer identifier unique device identifier, unique mobile wallet account identifier, mobile phone number or email, basket contents, payment type, GPS, wifi location, cell tower triangulation, store number, store address, date of transaction, time of transaction or any other information unique and specific to the transaction or store of an exact and unique offer which occurred through the mobile wallet provider (step 603). This is information on the transaction is used to measure against the original channel or media spend which was made, to determine the success or impact of the media spend or placement.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

In a separate embodiment after the coupon offer is redeemed as described earlier in this document there may also be further engagement with the customer whereby a separate SMS or form of media is sent to the customer a set period of time after her redemption providing her the ability to enter into a database (which may or may not be incentivized with an additional immediate coupon) of users whereby she will be given the ability to receive future offers to her mobile device or other methods she provided to connect to her. If she responds positively or in the affirmative to that message then she will be entered into the database.

In a separate embodiment immediately following the redemption of the mobile coupon, the customer is then provided with a marketing survey which may or may not be incentivized with an additional offer. (i.e. % discount, or 2 for 1 offer, etc.) on for the future transaction. This post transaction survey step enables the brand to capture analytics related to the customer experience, providing information for changes at the retail store or restaurant level, future products, customer preferences, and ultimately the opportunity to increase brand loyalty

1. A method of distributing offers comprising:
transmitting a message to a mobile device, wherein the message comprises an offer for a value to be applied for a purchase;
receiving a first response to the message from the mobile device;
sending a link to the mobile device in reply to the first response;
receiving a second response from the mobile device, wherein the second response comprises information used to determine whether the offer will be activated; and
validating the information from the second response to determine whether the offer will be activated.

2. The method of claim 1, further comprising:
activating the offer if the validation is successful.

3. The method of claim 2, further comprising:
discounting the purchase price based on the offer.

4. The method of claim 2, further comprising:
recording a purchase that uses the offer.

5. The method of claim 1, further comprising:
blocking access to the offer if the validation is not successful.

6. The method of claim 1, wherein the message is sent in a form selected from the group of a text message, QR code, tweet, social networking message, social media form of communication, near field communication, and email.

7. The method of claim 1, wherein the offer is selected from the group consisting of a coupon, discount, two-for-one offer, gift-card, and store credit.

8. The method of claim 1, wherein the second response comprises information regarding the location of the mobile device.

9. The method of claim 8, wherein the mobile device comprises a geographical positioning system (GPS) feature, the method further comprising:
receiving information from the mobile device indicating the location of the mobile device.

10. The method of claim 8, further comprising:
prompting a user to input information regarding the location of the device.

11. The method of claim 8, wherein location information is derived from wife.

12. The method of claim 8, wherein location information is derived from cell tower triangulation.

13. The method of claim 1, wherein the link comprises a prompt requesting information from the user of the mobile device.

14. The method of claim 1, wherein the second response comprises information selected from the group consisting of the mobile device user's bill total, products purchased, and services purchased.

15. The method of claim 1, wherein the second response comprises information selected from the group consisting of a unique store code, store address, and a code provided to the user of the mobile device.

16. The method of claim 1, further comprising:
querying mobile wallet providers to determine if the mobile device has the capability to use mobile wallet functionality.

17. The method of claim 16, further comprising:
prompting the user of the mobile device to download mobile wallet software.

18. The method of claim 16, further comprising:
transmitting the offer to a mobile wallet.

19. The method of claim 1, wherein the second response comprises payment information for the purchase.

20. A method of distributing offers comprising:
transmitting a message to a mobile device, wherein the message comprises an offer for a value to be applied for a purchase;
receiving a first response to the message from the mobile device;
sending a link to the mobile device in reply to the first response;
activating the offer when the mobile device interacts with a near field communications reader.
